(19) United States
(12) Patent Application Publication
(10) Pub. No.: US 2006/0201392 A1
(43) Pub. Date: Sep. 14, 2006

(54) Lightweight cementitious mixture

(76) Inventor: Matthew Piazza, Boynton Beach, FL (US)

Correspondence Address: Jesse R. Bucholtz;Jack Schwartz & Associates, Suite 1510, 1350 Broadway, New York, NY, 10018, US

(21) Appl. No.: 11/074,574

(22) Filed: Mar. 8, 2005

(51) Int. Cl. C04B 28/00; C04B 14/00

(52) U.S. Cl. 106/638; 106/814

(57) ABSTRACT

A mixture comprising at least one of water and a wetting agent and at least one of lightweight aggregate material and reinforcing fibers, a surfactant and cement. The at least one of lightweight aggregate material and reinforcing fibers is mixed with the at least one of water and wetting agent to fully saturate and wet out the at least one of lightweight aggregate material and reinforcing fibers. The surfactant is combined with the cement and the combination is mixed with the wet out at least one of lightweight aggregate material and reinforcing fibers to form a viscous mixture having a predetermined viscosity associated therewith allowing the mixture to be manipulated to form at least one final product.

### BACKGROUND OF THE INVENTION

1. Field of Invention

The present invention relates generally to a light weight cementitious (cement based) mixture produced from an ultra-high ratio of light weight aggregate materials and an ultra-low ratio of water to ready mix cement in combination with a chemical additive mixture(s). The resulting cementitious mixture allows for the creation of new and improved methods of manufacturing light weight cementitious materials as well as new and improved light weight cementitious products.

2. Description of Prior Art

Present day light weight cementitious materials are manufactured from a raw material mixture comprising cement and light weight aggregates such as vermiculite, purlite, shale, mica, pumice and other similar lightweight fiberous materials. Present day lightweight cementitious materials in their end use form have comparatively low psi (pounds per square inch) strengths (approximately 275 pounds) and very low tensile and flexural strengths (approximately 200 pounds) as compared to regular cement which will typically have a psi rating of 3000 and a tensile and flexural strength of 250 pounds.

One main cause for the lack of strength in conventional light weight cementitious materials is the high amount of water required to wet out the light weight aggregate material in addition to the water required in preparing the cement for pouring.

Light weight aggregate materials such as vermiculite are highly absorbent and must be wetted to the point of saturation before the materials can be manipulated, processed and effectively mixed with cement in a manufacturing process. It is this wetting process that negatively impacts the ultimate psi, tensile and flexural strengths of light weight cementitious materials in that water increases the weight while proportionately diluting the inherent strengths of cement. Therefore, it is desirable to produce a lightweight cementitious material having an increased psi rating and increased tensile and flexural strength.

The primary weakness of present day lightweight cementitious materials is the inherent inability to absorb reinforcing fibers during the production thereof, specifically in the mixing and pouring process. This inability is once again due to the fact that reinforcing fibers must also be wetted in order to be absorbed by and bound into the cementitious mix prior to the mix being poured. However, due to the saturation experienced as a result of wetting the light weight aggregate, any additional water content would render the resulting material unworkable and unusable. Thus, the resulting material having the increased water content could not be formable for use as an end product that is typically used in at least one of the building, construction and architectural trades.

State of the art light-weight cementitious materials are produced utilizing low ratios of lightening agents to cement, requiring much greater amounts of water due the high absorbency levels inherent in lightening agents. And even though water is a key ingredient in cement, it remains an undesirable element due to the fact that water is heavy and is highly dilutive. Water adds weight to and decreases the strength of the resulting cementitious materials. As such, light weight aggregate materials are currently added to cementitious material mixes in relatively low ratios. The end result being that present day light weight cementitious materials experience only minor reductions in weight but also significant reductions in strength.

Furthermore, another ingredient contained in conventional light weight cementitious materials are reinforcing fibers which add further strength to the resulting material. However, conventional lightweight cementitious materials will not absorb reinforcing fibers without the addition of ultra high quantities of water necessary to wet out the fiber. The ultra high quantites of water must be added in addition to the water for wetting out of the light weight aggregate material. If the reinforcing fibers are not wetted out they will remain dry and brittle, thus negating the binding and strengthening characteristics of the fibers. But, if properly wetted, the overall mixture would contain such high amounts of water, that the resulting mix would be diluted to a point wherein the resulting strength and substance of the materials would render the resulting product useless in the building, construction and architectural trades.

The marketplace is highly desirous of a light-weight cementitious material with high psi and tensile and flexural strengths. It is thus highly desirable to produce a light weight cementitious mixture that can be manufactured from mixes featuring ultra-high ratios of light weight aggregate materials such as vermiculite, purlite, shales, mica and pumice added to cement in a manner that the mixture matrix requires ultra-low quantities of water and is able to absorb ultra high quantities of reinforcing fibers.

It is further desirable to produce a light weight cementitious mixture that is highly viscous (thick, sticky and gummy) so as to produce stable, monolithic end use materials.

It is further desirable to produce a light weight cementitious mixture that on the one hand is highly viscous, yet on the other has an ultra-high ability to flow when handled and manipulated, an attribute normally associated with substances that have low viscosity. Such a mixture is able to randomly and uniformly disperse reinforcing fibers when mixed and to self level when poured, much like water, so as to readily facilitate the manufacture of light weight cementitious products whether, poured, injected, pressed, sprayed or extruded.

### SUMMARY OF THE PRESENT INVENTION

The present invention relates generally to a light weight cementitious (cement based) mixture produced from an ultra-high ratio of light weight aggregate materials and an ultra-low ratio of water to ready mix cement in combination with a chemical additive mixture(s). The resulting cementitious mixture allows for the creation of new and improved methods of manufacturing light weight cementitious materials as well as new and improved light weight cementitious products.

A primary object of the present invention is to provide a lightweight cementitious mixture and material that overcomes the shortcomings of the prior art.

Another object of the present invention is to provide a lightweight cementitious mixture for use as at least one of a building material, a construction material and an architectural material. Additionally, the lightweight cementitious material having a viscosity that requires ultra-low quantities of water when mixed with light weight aggregate materials.

A further object of the present invention is to produce a lightweight cementitious mixture that is both sticky and has in increased flowability associated therewith.

Yet another object of the present invention is to produce a lightweight cementitious mixture that can be at least one of poured, injected, pressed and extruded. The lightweight cementitious material is also able to self-level itself after being manipulated as discussed above.

Still another object of the present invention is to produce a cementitious mixture that absorbs ultra-high levels of fibers added thereto. Furthermore, the lightweight cementitious mixture is able to consistently disperse ultra-high levels of fibers in a highly random yet uniform manner. The cementitious mixture of the present invention is viscous mixture for use in producing building, construction and architectural materials that overcomes the limitations of prior art building, construction and architectural materials.

It is another object of the present invention to produce a viscous cementitious mixture that has an ultra high ratio of light weight aggregate materials contained therein as compared to cement. The viscous mixture is produced by optimally dampening the light weight aggregate material when mixed with cement.

A further object of the present invention to produce a viscous cementitious mixture that is able to absorb ultra high quantities of reinforcing fibers. The absorbed fibers are then randomly yet consistently dispersed in a uniform manner throughout the mixture. This random consistent and uniform dispersion is maintained even when the mixture is at least one of poured, injected, sprayed, pressed or extruded.

It is still yet another object of the present invention to produce a viscous cementitious mixture that is self leveling when poured, injected, pressed or extruded.

It is a further object of the present invention to produce the viscous cementitious material for use in forming at least one of building, construction and architectural materials by combining chemistry with at least one of lightweight aggregate material and reinforcing fibers and cement.

Still another object of the present invention is to produce a viscous cementitious material wherein the chemistry comprises at least one of a self-consolidator, a viscosity modifier, a surfactant, a superplasterizer, an anti-segregation agent, an anti-shrinking agent, a wetting agent, a self compacting agent, an air entraining agent, a water repellent agent, a natural pozzllate and an accelerating agent.

Yet another object of the present invention is to produce a viscous cementitious material wherein the light weight aggregate material is at least one of vermiculite, purlite, shales and pumice.

An even further object of the present invention is to produce a viscous cementitious material wherein the reinforcing fibers include at least one of structural fibers, fibulated fibers and fiberglass strands. Additionally, the reinforcing fibers can be substituted and/or supplemented with reinforcing fibers having at least one of nanoparticles, nanotubuoles or formed in a nano-slurry.

It is another object of the present invention to add at least one of one part sand, one part silica and other high density aggregates to the cementitious mixture in order to modify the mixture so as to produce building, construction and architectural material with ultra psi strength in amounts in excess of 12,000 psi while remaining lighter than the highest psi strength of conventional cementitious materials.

Another object of the present invention is to add a surfactant to the cementitious mixture. The surfactant is a chemical whose molecules are absorbed at air-water or solid-water interfaces. That is, the molecules are abstracted from the solution phase and concentrated at the surface. When a surfactant molecule is absorbed at an interface, the nature of the molecule allows its polar and non-polar ends to arrange themselves so as to be in the phase each end prefers, or excluded from the phase it dislikes. At an air-water interface, the polar head is in the water phase while the non-polar tail is excluded from the water and reaches for the air phase. Thus, the molecule can satisfy both aspects of its dual polar nature. This ability is the reason for its strong absorption at the interface and its surface activity. The important consequence of this absorption is a lowering of the surface tension; the higher the concentration of surfactant in solution, the lower the surface tension, thus producing lower viscosity and ultra-high flowability.

In addition, a superplasticizer may also be added to the cementitious mixture for the purpose of further enhancing the flowability of the mixture.

Additionally, a self-compacting agent may be added to the cementitious mixture for the purpose of still further enhancing the flowability of the mixture.

Furthermore, an air-entraining agent may be added to the cementitious mixture. The use of an air-entraining agent creates a stable air void with homogeneous air bubble size and spacing. The use of an air entraining agent further provides an increased resistance of the end use material to the negative effects of the freeze-thaw phenomenon that is pervasive in conventional cementitious materials.

Furthermore, a non-ionic surfactant may be added to the cementitious mixture, further reducing the absorption rates of the cement and light weight aggregate materials (such as vermiculite) in the viscous mixture, improving the ability to manipulate the material and increasing the strength and durability of the end use material.

Furthermore, a water repelling agent may be added to the cementitious mixture. The water repelling agent binds to the light weight aggregate material and cement in order to prevent those materials from absorbing additional water molecules.

Additionally, an agricultural liquid or gel wetting agent may be used in the cementitious mixture allowing for a further reduction of water in the mixture. This also eliminates the problem of over wetting the light weight aggregate material and cement, thus producing a highly stable, monolithic and homogeneous mixture. Furthermore the addition of such a wetting agent allows the lightening agent to hydrate over time wherein water molecules are released into the cement thereby constantly building the strength of the cementitious mixture over time.

Furthermore, a natural pozzolate may be added to the mixture to further inhibit the effects of the freeze thaw phenomenon.

Another object of the present invention is to produce a viscous mixture wherein the resulting materials formed therefrom may include encapsulated cores and boxed and also may be formed in any desired shape by being at least one of poured, injected, pressed and extruded.

Another object of the present invention is to produce a viscous mixture that can form a plurality of building, construction and architectural products including but not limited to architectural elements such as window and door trim, balustrade, columns and shutters, panels, roof tile, ceiling tile, countertops, hearths, furnishings, curtain wall, backer board and decking.

Another object of the present invention is to produce a viscous mixture that is simple and easy to use as compared to conventional cementitious materials.

Another object of the present invention is to produce a viscous material that is economical in cost to manufacture as compared to conventional cementitious materials.

Additional objects of the present invention will appear as the description proceeds.

### BRIEF DESCRIPTION OF THE DRAWINGS

Various other objects, features and attendant advantages of the present day invention will become more fully appreciated as the same becomes better understood when considered in conjunction with the accompanying drawings, in which kike reference characters designate the same or similar parts throughout the several views.

FIG. 1 is a flow diagram detailing the method and process for producing the lightweight cementitious mixture of the present invention.

### DETAILED DESCRIPTION OF THE PREFERRED EMBODIMENT

When producing building, construction and architectural materials with the use of cement and light weight aggregate materials such as vermiculite, purlite, shales and pumice and reinforcing fibers, the light weight aggregate material should be placed into the mixture first before the addition of water. The light weight aggregate material must first be wet out with at least one part water and one part wetting agent. The light weight aggregate material should be wet out until a sticky glue-like composition is formed. Thereafter, the surfactant chemistry is added to the cement which is then combined with the wet out light weight aggregate material. Ultra high quantities of reinforcing fibers are added to the final mixture. When mixed, the composition produces an ultra low viscosity cementitious substance. This viscous substance can be poured, pressed, injected or extruded into a final mold in a manner that is self leveling and randomly and uniformly disperses the reinforcing fibers into the resulting final product material produced using the viscous material of the present invention.

The ultra low viscosity allows the material of the present invention to be manipulated in ways that conventional cementitious substances cannot be presently manipulated. The resulting viscous substance may then be manipulated to form a plurality of building, construction and architectural materials with attributes and benefits heretofore not achieved in the marketplace.

Specifically, the final product formed from the viscous cementitious material, due to light weight aggregate materials being much lighter than cement, is a manufactured cementitious material that is ultra light weight and up to 65% lighter than cement and cast stone. This significant reduction in weight is exemplary of a lightweight aggregate material such as vermiculite which lighter than cement by a factor of 19 to 1.

Additionally, due to the ultra-high fiber content and random, uniform and consistent dispersal thereof, the viscous cementitious mixture is a manufactured cementitious material that has ultra-high flexural, tensile and psi strength as compared to conventional cementitious material and known lightweight cementitious material.

Furthermore, the viscous cementitous material of the present invention, when used to form at least one of a building, construction and architectural material, produces a material that is ultra mold resistant. This is due to the primary cause of mold being the retention of moisture in or on a material and that the matrix created in the viscous material that is the object of the present invention “breathes” i.e. allows moisture to escape thus, inhibiting the retention of moisture and the growth of mold. Thus, the resultant material is able to reduce the negative health affects caused by prior art building materials such as wood and cement.

The viscous material of the present invention, when manufactured, produces a cementitious material that is non-combustible and does not emit toxic fumes as do conventional foam materials. At least in part, this is due to vermiculite being a fire-proof substance and due to the high ratio of vermiculite to cement in the mixture. The end use material produced therefrom is fire-proof and does not spall under intense heat and does not emit toxic gasses as do conventional cementitious materials and conventional foam products.

In addition to the reduction in negative health affects and improved fire-safety of the cementious material produced from the viscous material, the cementitious material is highly resistant to termites and other such pests that infest wood and foam. This is due to the cement of the mixture being substantive enough to alter the state of lightweight aggregates such as vermiculite so as to make the material non-appealing to pests thus preventing the pests from at least one of nesting and burrowing therein as well as preventing the pests from utilizing the material as a food source.

The cementitious material produced from the viscous material of the present invention is manufactured in a manner such that, due to the high ratio of light weight aggregate (such as vermiculite) to cement, is permeable enough to accept a nail or screw, yet cohesive and strong enough not to split and to maintain the integrity of the material while remaining light enough to not create shear stress when glued or affixed to the very lightest of building material substrates. Furthermore, also due to the high content of light weight aggregate material in combination with the mixture's chemical matrix, the manufactured cementitious material can be cut and trimmed in the same manner and with the same tools as wood.

In addition, the cementitous material manufactured from the viscous material can be affixed to a variety of substrates including but not limited to, cement block, wood, metal, foam, exterior and interior sheet rock and cementitious boards. This ease of affixation is due directly to the reduced weight of the material which results from the high ratio of lightweight aggregates as compared to cement contained therein. This high ratio of aggregates as compared to cement further enhances the materials efficacy as an insulating material.

The cementitious material of the present invention further has in increased permeability level. Specifically, due to the materials ability to repel and otherwise not absorb water, the material has a permeability rating of 4% meaning that when placed in water the material will absorb 4% of its weight when immersed therein.

A further improved property of the manufactured cementitious material of the present invention is the reduction or elimination of cracking typically associated with a freeze-thaw situation. The cementitious material possesses a unique ability to absorb high quantities of natural pozzllate and air entraining agents and thus is highly resistant to the thermal co-efficient of expansion and will not crack when thawed after freezing. This further improves the structural integrity and extends the life of the at least one of building, construction and architectural material formed from the viscous material of the present invention.

The resulting building, construction and architectural materials produced using the viscous cementitious mixture was tested for compressive and flexural strength in each of a seven (7) day test and 28 day test in accordance with ASTM C39 and C78. The compressive strength exhibited over the seven day span being an average of 1740 psi while the 28 day test exhibited an average of 2800 psi. The flexural and tensile strength exhibited over the seven day span was 450 psi while the 28 day span exhibited an average of 650 psi. When weighed, the viscous mixture had a raw dry weight of 32 pounds per cubic foot as compared to 94 pounds for a conventional cementitious mixture as the aggregate materials within the conventional cementitiou mixture are replaced with lighter weight materials in the viscous mixture.

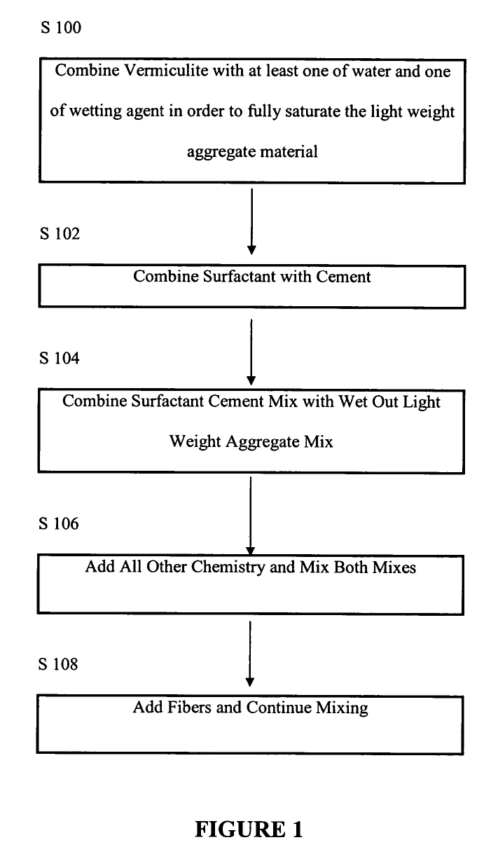

The viscous cementitious mixture of the present invention is produced as discussed hereinafter with specific reference to FIGS. 1. FIG. 1 is a flow diagram showing the method for producing the viscous mixture of the present invention. In order to produce the viscous mixture, a desired amount of light weight aggregate material such as vermiculite, purlite, shales, pumice and mica is combined with at least one of water and wetting agent in an amount able to substantially saturate the light weight aggregate as discussed in step S100. Additionally, various fibers may be added to the light weight aggregate material as desired. A predetermined amount of cement is then combined with a surfactant as stated in step S102. In step S104, the cement-surfactant mixture formed in step S102 is combined with the wet out light weight aggregate material from step S100 and the combination is mixed together as discussed in step S106. Additional fibers and natural pozzolants may then be added to the mixture as necessary and mixing continues as discussed in step S108 in order to produce a viscous cementitious material.

Such fibers are added to the cementitious materials during the mixing process after which the mix is poured into a static state awaiting curing and transformation into a finished product. An inherent drawback of conventional light weight cementitious materials during the production (mixing and pouring) process is the high level of viscosity of the material. Viscosity is not desirous in a fiber-reinforced cementitious mix because such material cannot be uniformly poured and the fibers cannot be evenly distributed within the mix, resulting in clumping and layering of the fibers. Thus, the benefits of conventional light weight fiber-reinforced cementitious mixes are significantly limited by the amount of fiber that can be absorbed within a cementitious mix and uniformly dispersed when poured and cured in an end use application without adding high quantities of water, which in turn dilutes the mixture. The above process corrects this drawback and produces a viscous cementitious mixture wherein the added fibers are uniformly distributed throughout.

The viscous cementitious mixture produced as described above has a viscosity such that the mixture can be processed in a manner and subsequently used in manufacturing processes different than any other previously produced cementitious mixture or product. The uniqueness of the present viscous mixture facilitates the bonding of raw materials such as cement, light weight aggregates, fibers, and chemicals such as surfactants and wetting agents that normally do not bond together to produce building, construction and architectural materials having a matrix with compressive flexural and tensile strengths that are substantially greater than those of conventional cements.

Furthermore, the viscous cementitious material has a viscosity such that the material can be processed and manufactured in a manner different and more efficiently and cost effective than state of the art cementitious materials. Specifically, the object of the present invention can be processed using equipment and techniques generally associated with the manufacture of plastics and food processing. These techniques include but are not limited to injection molding, extrusion and press molding. These techniques allow for more efficient, versatile and cost effective production of cementitious building, construction and architectural materials.

Upon mixing, producing by means of pouring, pressing, injecting, spraying or extruding and curing, the resulting material for use in building, construction and architectural applications creates attributes substantively superior to those of concrete and cast stone, including a substantial reduction in weight of 65%, a substantial increase in flexural and tensile strength of 650 to 850 pounds as compare to approximately 250 pounds in conventional cement, and in excess of 2800 psi, nearly five times the strength of conventional light weight cements.

The cementitious material formed from the viscous material of the present invention is extremely lightweight due to the lightweight aggregate material used in the formation thereof. A preferred example of a lightweight aggregate material for use in the present invention is vermiculite, which produces a final product that is up to 65% lighter than conventional cementitious materials. The properties of vermiculite and cement mixtures are shown below in Table 1.

TABLE 1
Physical Properties of Vermiculite/Cement Mixtures

| | | Wet | Oven Dry | Comprehensive | |
|---|---|---|---|---|---|
| | | Density | Density | Strength 28 | “K” |
| Cement | Vermiculite | PCF | PCF | Days PSI | Factor |
| 1 | 4 | 55-58 | 30-34 | 225-275 | .79 |
| 1 | 5 | 50-54 | 26-30 | 175-225 | .74 |
| 1 | 6 | 45-49 | 23-26 | 140-175 | .70 |
| 1 | 7 | 43-45 | 21-23 | 125-140 | .67 |
| 1 | 8 | 40-43 | 19-21 | 100-125 | .64 |

The viscous mixture of the present invention, in addition to a light weight aggregate material such as vermiculite and cement may include a combination of raw materials as shown in Table 2, below. The raw materials are mixed to form the viscous mixture that is the object of the present invention.

TABLE 2
Raw Materials

Portland cement or its equivalent
Light weight aggregate (such as vermiculite)
Natural pozzolate
Fibers, including glass fibers, synthetic macro fibers and fiberlating fibers
Chemical additive including, wetting agent, self compacting agent, ionic
surfactant, water repellent agent, viscosity modifier, superplastesizer, anti-
segregation agent, anti-shrinking agent, air entraining agent and
accelerating agent

The amounts of the raw materials used to produce the viscous mixture of the present invention may vary depending on the desired attributes of the manufactured material. However, while the amount of raw materials may vary, the resulting viscous material still retains the same degree of uniform flowability and workability. The present invention is a completely stable and monolithic viscous mixture that may be poured, injected, pressed or extruded in a homogeneous manner so as to be manufactured into any shape or form of building, construction or architectural material. The resulting material has numerous properties heretofore not achieved in cementitious materials, including; (i) ultra light weight, (ii) ultra high tensile, flexural and psi strength, (iii) highly mold resistant, (iv) fireproof, (v) termite proof, (vi) affixed to substrates in the same manner and as easily as wood and foam, (vii) cuts and trims in the same manner and as easily as wood, (viii) highly resistant to the absorption of water, (ix) ultra resistant to the damaging effects of the freeze thaw phenomenon, and (x) affixes to a variety of substrates, including lightweight substrates such as foam and stucco without sheer weight problems.

In addition, the amounts of the various raw materials used to produce the viscous mixture, the viscous mixture produces a manufactured material that is environmentally friendly and unlike conventional cement, foam and wood products, it is rated as Leed product. A Leed rating is internationally valued as “green” and “environmentally friendly” an objective desired by architects and builders throughout the United States.

To the accomplishment of the above and related objects, this invention may be embodied in the form illustrated in the accompanying drawings, attention being called to the fact however, that the drawings are illustrative only, and that changes may be made in the specific construction illustrated and described within the scope of the appended claims.

It will be understood that each of the elements described above, or two or more together may also find useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A mixture comprising:
a) at least one of water and a wetting agent;
b) at least one of lightweight aggregate material and reinforcing fibers, said at least one of lightweight aggregate material and reinforcing fibers being mixed with said at least one of water and wetting agent to fully saturate and wet out said at least one of lightweight aggregate material and reinforcing fibers;
c) cement; and
d) a surfactant; wherein the surfactant is combined with the cement and the combination is mixed with said wet out at least one of lightweight aggregate material and reinforcing fibers to form a viscous mixture having a predetermined viscosity associated therewith allowing said mixture to be manipulated to form at least one final product.

2. The mixture as recited in claim 1 wherein said mixture further comprises at least one of a self-consolidator, a viscosity modifier, a surfactant, a superplasterizer, an anti-segregation agent, an anti-shrinking agent, a wetting agent, a self compacting agent, an air entraining agent, a water repellent agent, a natural pozzllate and an accelerating agent combined with said mixture.

3. The mixture as recited in claim 1, wherein said lightweight aggregate material is at least one of vermiculite, purlite, shales and pumice.

4. The mixture as recited in claim 1, wherein said reinforcing fibers is at least one of structural fibers, fibulated fibers and fiberglass strands.

5. The mixture as recited in claim 1, wherein said reinforcing fibers include fibers formed from at least one of nanoparticles, nanotubuoles or formed in a nano-slurry.

6. The mixture as recited in claim 1, wherein said final product produced from said mixture is at least one of building materials, construction materials and architectural materials.

7. The mixture as recited in claim 1, wherein said final product is at least one of window and door trim, balustrade, columns and shutters, panels, roof tile, ceiling tile, countertops, hearths, furnishings, curtain wall, backer board an decking.

8. The mixture as recited in claim 1, wherein said mixture is able to be manipulated by at least one of pouring, spraying, injecting, pressing and extruding said material.

9. The mixture as recited in claim 1, wherein prior to formation of said final product, said mixture is self-leveling.

10. The mixture as recited in claim 1, wherein said final product is fireproof.

11. The mixture as recited in claim 1, wherein said final product is at least one of pest resistant and mold resistant.

12. The mixture as recited in claim 1, wherein said final product is affixable via an adhesive agent to a substrate.

13. The mixture as recited in claim 1, wherein said final product is crack-resistant upon undergoing a freeze-thaw phenomenon.

14. The mixture as recited in claim 1, wherein said reinforced fibers are uniformly and randomly distributed throughout the mixture thereby increasing a tensile and flexural strength assocated with said final product.

15. A method for producing a viscous mixture comprising the activities of:
a. combining at least one of a lightweight aggregate material and reinforcing fibers with at least one of water and a wetting agent to wet out the at least one of a lightweight aggregate material and the reinforcing fibers to form a first combination;
b. combining a surfactant with cement to form a second combination;
c. combing the first combination with the second combination to produce the viscous mixture; and
d. mixing the viscous mixture.

16. The method as recited in claim 15, prior to said mixing, further comprising the activity of combining at least one of self-consolidator, a viscosity modifier, a surfactant, a superplasterizer, an anti-segregation agent, an anti-shrinking agent, a wetting agent, a self compacting agent, an air entraining agent, a water repellent agent, a natural pozzllate and an accelerating agent combined with said mixture.

17. The method as recited in claim 15, further comprising the activity of manipulating the viscous mixture; and producing a final product from the viscous mixture.

18. The method as recited in claim 17, wherein said activity of manipulating comprises at least one of pouring, injecting, pressing and extruding the viscous material.

19. The method as recited in claim 17, wherein said activity of producing comprises producing at least one of building materials, construction materials and architectural materials including at least one of window and door trim, balustrade, columns and shutters, panels, roof tile, ceiling tile, countertops, hearths, furnishings, curtain wall, backer board an decking.
